(19) United States
(12) Patent Application Publication
(10) Pub. No.: US 2012/0116751 A1
(43) Pub. Date: May 10, 2012

(54) PROVIDING MESSAGE TEXT TRANSLATIONS

(75) Inventors: Gianluca Bernardini, Rome (IT); Fabio Cerri, Rome (IT); Michele Crudele, Rome (IT); Bernardo Pastorelli, L'Aquila (IT)

(73) Assignee: International Business Machines Corporation, Armonk, NY (US)

(21) Appl. No.: 13/292,580

(22) Filed: Nov. 9, 2011

(30) Foreign Application Priority Data
Nov. 9, 2010 (FR) 10190563.6

(51) Int. Cl. G06F 17/28

(52) U.S. Cl. 704/3

(57) ABSTRACT

A system management product installed in a distributed computing environment can efficiently provide appropriate translations of message texts without preinstalled catalogues of translations. When a management activity that includes displaying a message text is performed, the system management product determines that a translation of the message text in the target language is unavailable at a client computer. A translation of the message text into the target language is requested from a translation service. A plurality of different translations of the message text in the target language is received. The plurality of different translations is displayed at the client computer. Feedback about the plurality of different translations is requested. The feedback is provided to the translation service. An indication of a vote for a preferred translation of the message text in the target language based on the feedback is recorded.

### RELATED MATTERS

This application claims priority, pursuant to 35 U.S.C. §119(a), of French Patent Application 10190563.6, filed Nov. 9, 2010. This patent application incorporates by reference the prior filed French Patent Application 10190563.6 in its entirety.

### BACKGROUND

The present inventive subject matter relates to translation of messages in different languages by an application in a distributed computer environment, and limiting the amount of data stored for translation in the computers. The inventive subject matter relates to a distributed computer environment comprising a system management product running on a server computer and communicating with agent software running on distributed computers. The server computer and the distributed computers are connected through a network. Furthermore, the system management product is for automated implementing, administrating, adjusting, controlling, monitoring and correction of information technology (IT) components.

System management refers to the management of IT systems in a client/server architecture. Such client/server solutions are used in computer networks where services are centrally provided on at least one server in connection with multiple client computers. The server used for the system management is a centrally installed service that provides user interfaces and functionality for managing the clients to an administrator of the computer network. Typical system management tasks initiated from the management server are the automated implementation, administration, adjusting, controlling, monitoring and correction of IT components and IT business services on the clients. These tasks include software installations, especially of third party software products, and inventory data collections and can require rebooting the system.

The client in respect to system management is an agent software, which is installed on a client computer and that is responsible of receiving and performing the above listed management tasks initiated by the management server. The agent software sometimes requires an interaction of the user of the client computer, especially when a license agreement for a modification or installation of an IT component has to be accepted, the installation of a new component has to be confirmed, the system has to be rebooted, or a policy violation has to be solved.

The user interaction requires displaying text messages regarding the interaction. In computer networks, especially those of international companies, where employees speak different languages, the text messages have to be displayed in the proper language of the user so that he can correctly interact. Central administration has to deal with different users who speak different languages, so it is important to display the text messages in the proper language of the respective user. Therefore, the agent software itself has been already provided with the text messages to be displayed in the proper language.

Accordingly, the agent software is analyzed in advance for localizable resources, so that these resources can be segregated into a localized catalogue or resource bundle. Additionally, all resources are translated from the language, in which they are provided, into all languages supported by the management system. Accordingly, one catalogue for each language is created. On the client side, an API is provided for delivering the text messages at run time from the catalogue in the requested language. In order to provide the right catalogue to the client, either the entire set of catalogues is delivered to the agent software so that the right catalogue can be chosen at runtime or the right catalogue is chosen during the installation of the agent software so that only one catalogue is installed. In both cases the settings of the client can be evaluated to determine the proper catalogue.

### SUMMARY

Embodiments include a method directed to efficiently providing appropriate translations of message texts without preinstalled catalogues of translations. A management activity that includes displaying a message text is performed. It is determined that a translation of the message text in the target language is unavailable at a client computer. A translation of the message text into the target language is requested from a translation service. A plurality of different translations of the message text in the target language is received. The plurality of different translations is displayed at the client computer. Feedback about the plurality of different translations is requested. The feedback is provided to the translation service. An indication of a vote for a preferred translation of the message text in the target language based on the feedback is recorded

### BRIEF DESCRIPTION OF THE DRAWINGS

The present embodiments may be better understood, and numerous objects, features, and advantages made apparent to those skilled in the art by referencing the accompanying drawings.

FIG. 1 shows different components of an IT architecture and their connections,

FIG. 2 shows a flowchart of a method for displaying a text message in a target language to a user on a client computer including steps for improving the translation of the message text according to alternative I,

FIG. 3 shows the flowchart of a method for improving the translation of the message texts according to alternative II, and

FIG. 4 shows a detailed flowchart of the internal behaviour of step S4.

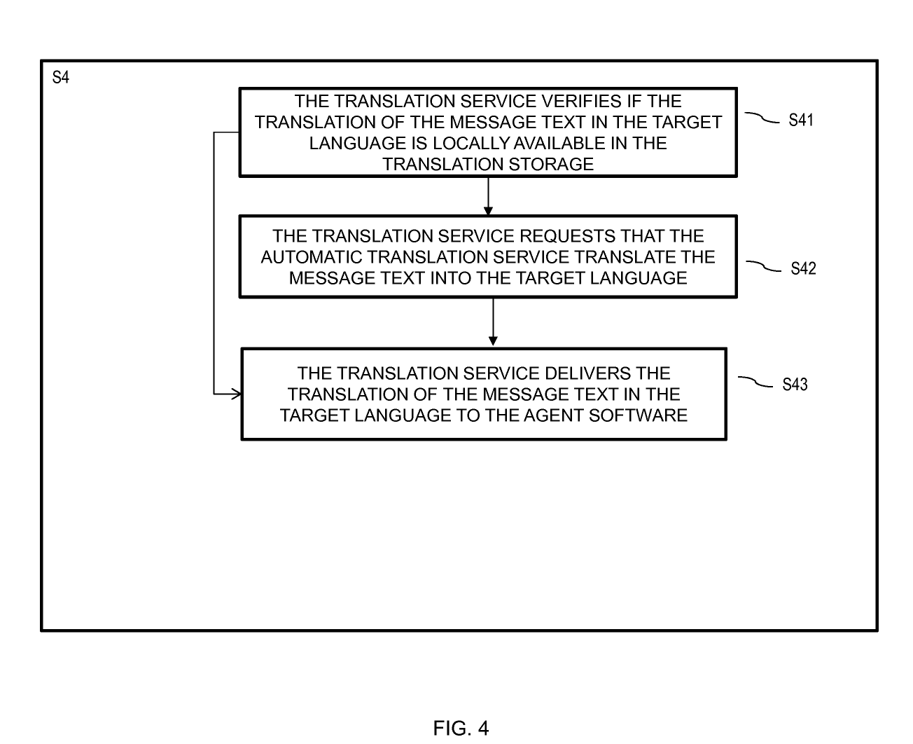

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

A system management product as a platform can be used by several third party software products. Accordingly, text messages used by the third party software products form part of localizable resources and require translation. If text messages are not provided in certain language catalogues, inconsistencies may occur. Further, a set of multiple catalogues requires a large amount of data to be transmitted to the client and to be stored locally thereon. If just one catalogue is chosen during the installation of the agent software, switching to a different language on the client leads to updating the installation with another language catalogue, which requires additional management activities.

Also, the system management product itself, as well as the third party software products, have to be provided already at installation time with a complete set of language catalogues containing translations for all localizable resources. Usually, the owner of the network is responsible for providing these translations and therefore has to install a translation process for all necessary languages. This slows down the introduction of new policies and the installation of new third party software products or new versions thereof

Further problems may arise when the system management product is being customized, e.g. by an administrator of the network. Built-in facilities, like a scripting language of graphical tools, can be used to extend the capabilities of the system management product. Also, the extension may cause user interaction and additional messages to be provided to all users in the proper language. Nevertheless, administrators are usually not qualified to provide required translations, so that messages might be displayed to the user only in one language. Translation of the additional messages will delay the deployment of the extensions.

Accordingly, displaying a text message in a target language to a user on a client computer, which can be centrally managed by a system management product with an agent software running on the client computer and connecting to a central management service. First, analyze if a translation of the message text is required and, in case the translation is necessary, request it on demand from a server. This implies that the agent software does not contain a catalogue of text messages translated into the target language, so that the agent software itself only comprises a small amount of data. Additional message texts can easily be added to the distributed software product, since necessary translations are provided at runtime. Verification if the message text is already provided in the target language can be done e.g. by comparing a system information about the installation on the client computer or user information to the language of the text message to be displayed. The translation service can be part of the central management service or an individual service used by the system management product. Accordingly, the translation service can be provided on a server inside the managed architecture or outside as a completely independent third party translation service.

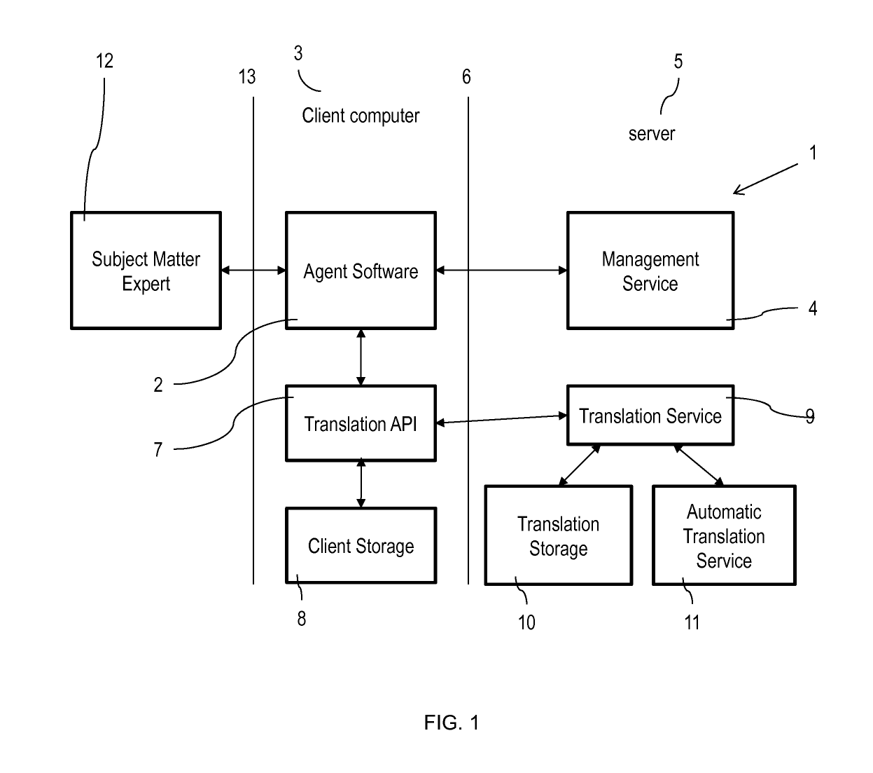

Referring now to FIG. 1, a distributed software product 1 for a system management is shown. The distributed software product 1 comprises an agent software 2 installed on a client computer 3 and a management service 4 installed on a central server 5. The client computer 3 and the server 5 are connected by a network connection 6, which is a common network connection including a connection via the internet. The network connection 6 allows the agent software 2 and the management service 4 to communicate to perform IT management tasks.

The agent software 2 communicates with a translation API 7, which is running on the client computer 3. The translation API 7 has access to a client storage 8. The translation API 7 communicates with a translation service 9, which is also located on the server 5 in this embodiment, via the network connection 6. Nevertheless, in alternate embodiments, the translation service 9 can be located on a different server and be connected via a different network connection. The translation service 9 is connected to a translation storage 10 and an automatic translation service 11 via local or network connections. The translation storage 10 can be of any kind of storage media.

A subject-matter expert 12 interacts with the agent software 2 via a user interface 13, which can include common user interface elements like a display, a keyboard, a mouse and so on. The management service 4 initiates a management task on the client computer 3 by the agent software 2, which may include the appearance of a message text via a user interface 13 to the user 12.

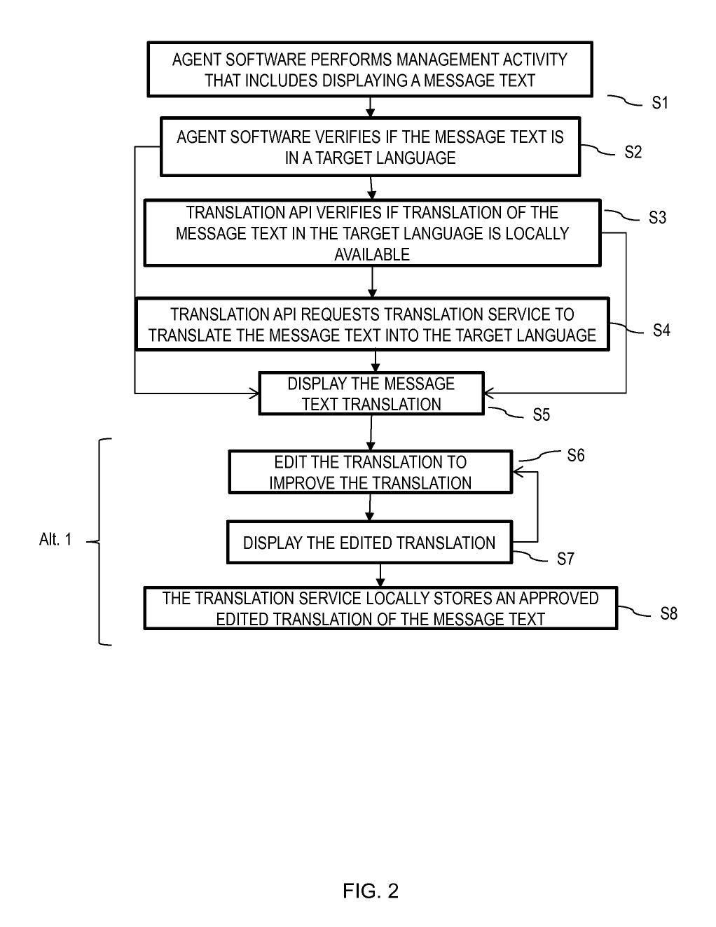

Now referring to FIG. 2, a flowchart of example operations for displaying a text message in a target language to the user 12 on a client computer 3 is shown. In step Si the agent software 2 performs a management activity, which is initiated from the management service 4. The management activity includes displaying a message text to the user 12.

In step S2 the agent software 2 verifies if the message text is provided in the proper language of the user 12, which is the target language. This verification is done evaluating a system information available on the client computer 3, in this case a language setting of the user 12. In case the message text is already provided in the target language, the method continues with step S5. Otherwise, the method continues with step S3.

In step S3 the translation API 7 verifies if a translation of the message text in the target language is already available in the client storage 8. In case the translation of the message text in the target language is locally available on the client 3, the method continues with step S5. Otherwise, step S4 is executed next.

In step S4, the translation API 7 requests a translation of the message text into the target language from the translation service 9 via the network connection 6. This step S4 comprises steps S41 to S43, which are performed by the translation service 9 on the server 5. In step S41, the translation service 9 verifies if the translation of the message text into the target language is already locally available in the translation storage 10. This is the case, when the translation of this message text into this target language has already been requested in advance and is stored in the translation storage 10 for future use. In case the verification of step S41 provides that the translation of the message text in the target language is already available, the method continues with step S43. Otherwise, the translation service 9 requests in step S42 a translation of the message text into the target language from the automatic translation service 11. The automatic translation service 11 subscribes to at least one of the services publically available, like for example “babel fish” or “translate.google.com”.

In step S43 the translation service 9 delivers the translation of the message text in the target language, which is either taken from the translation storage 10 or which was provided by the automatic translation service 11, and returns it to the agent software 2.

In step S5, the message text is displayed to the user 12 via the user interface 13 in the target language.

Additionally to this basic method for displaying the translation of the message text in the target language to the user 12, two alternatives for further processing are provided for improving the translation of the message text into the target language. This can be provided to subject matter experts 12 as users and deactivated for all other users 12. Furthermore, the further processing can be deactivated.

Alternative I is shown in FIG. 1 and comprises steps S6 to S8. In step S6, the subject matter expert 12 verifies the translation of the message text into the target language and decides that improvement of the translation is required. Accordingly, he edits the displayed translation of the message text and makes the necessary amendments.

In step S7, the edited translation of the message text is displayed as an update on the client computer 3 by the agent software 2 via the user interface 13. In case further amendments are required, the user 12 can decide to return to step S6 or give a final approval to the amended translation of the message text. The improved translation of the message text is then transmitted to the translation API 7 and further via the network connection 6 to the translation service 9, which stores it locally in the translation storage 10 in step S8. In case a translation of the message text is already available, the previous translation is either replaced by the improved translation of the message text or additionally stored.

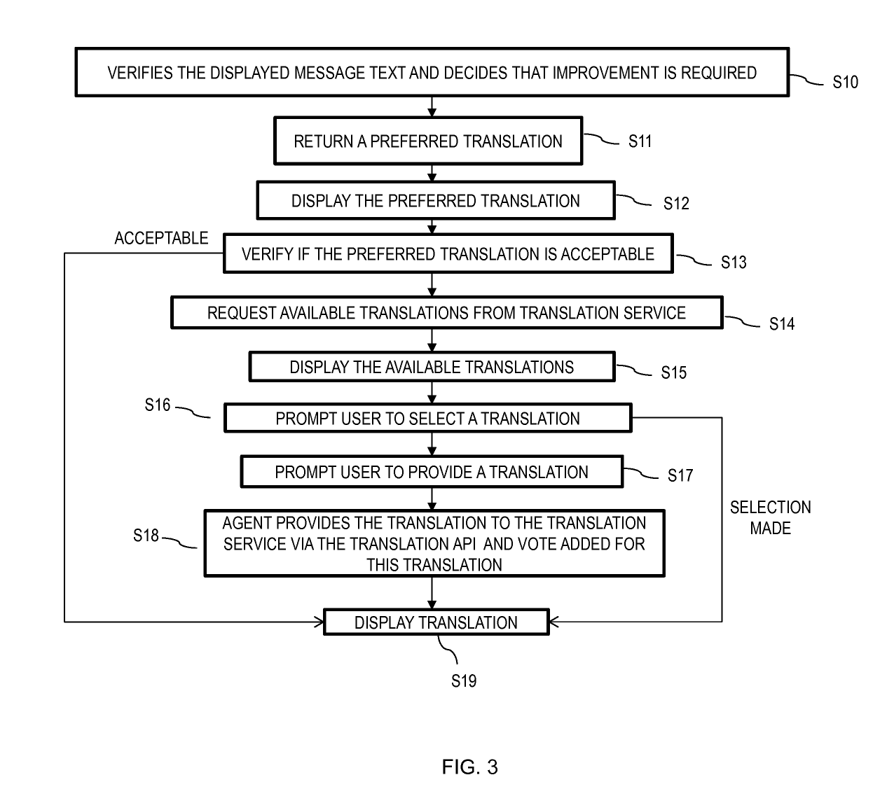

Referring now to FIG. 3, alternative II for improving the translation of the message text into the target language is shown. Alternative II can replace alternative I comprising steps S6 to S8.

In step 510, the user 12 verifies the displayed message text and decides that improvement is required. Accordingly, the agent software 2 requests alternative translations of the message text from the translation API 7, which connects via the network connection 6 with the translation service 9.

In step S11 the translation service 9 verifies in accordance with step S41, if a translation of the message text is available in the translation storage 10. In this case, a preferred translation from the available translation is returned via the translation API 7 to the agent software 2. In case just one translation is available, this translation is automatically taken as the preferred translation. Otherwise, the translation service 9 evaluates a mark associated with each translation and chooses the translation with the indication of a preferred translation. Alternatively, the preferred translation is simply the last selected translation.

In step S12 the agent software 2 displays the preferred translation of the message text to the user 12 via the user interface 13.

In step S13, the user 12 verifies if the preferred translation of the message text is acceptable. In this case, the method continues with step S19. Otherwise, in step S14 the translation service 9 is requested as already described in detail to provide all available translations to the client. This includes all locally available translations from the translation storage 10 and all translations that can be obtained from the automatic translation service 11 according to step S42.

In step S15 the agent software 2 displays all available translations of the message text to the user 12 in the form of a list.

Subsequently, the user 12 selects in step S16 one of the available translations of the message text as a preferred translation. This selection is also considered as a vote for determining the preferred translation according to step S11. The vote is transmitted via the translation API 7 to the translation service 9 and evaluated to update the marks for determining the preferred translation. In this case, a simple vote is chosen consisting in the accumulation of the preferred votes for the different translations available in the translation storage 10. The number of preferred votes is accumulated and the translation with the highest number of votes is considered as preferred translation of the message text. In more sophisticated a way of providing feedback, each available translation can be voted individually in a certain range of marks and/or different technical translation aspects (e.g. wording, grammar, . . . ), so that the quality of each translation can be evaluated. A simple evaluation consists in providing the last selected translation as preferred translation. It is also possible to combine any of the afore-mentioned voting mechanisms or to implement other means of voting which allow a more detailed feedback. The method then continues with step S19.

In case none of the available translations in step S16 satisfies the user 12, in step S17 the agent software 2 offers via the user interface 13 to the user 12 to provide a further translation of the message text. The translation can be based on any of the available translations as displayed to the user 12 in step S16. Alternatively, the user 12 generates a new translation of the message text from the scratch.

When the user 10 finishes with the translation, the translation of the message text is in step S18 provided from the agent 2 via the translation API 7 to the translation service 9 as a further translation of the message text and stored in the translation storage 10. At the same time, a vote is added to this newly edited translation for determining the preferred translation.

In step S19, the final translation of the message text in the proper language is displayed on the client computer 3 via the user interface 13 to the user 12 for final approval.

Although the current embodiment of the present inventive subject matter is implemented with just a single server 5 for providing the management service 4 and the translation service 9, it is to be noted that any of the services 4, 9 can be provided on a different server. This refers to the server computer 5 itself as well as to its location, which means that the services 4, 9 can be located at different places in the IT architecture. The translation service 9 can even be fully external in respect to the IT architecture. Also the translation storage 10 can be separated from the translation service 9 itself. Finally, also the automatic translation service 11 can be completely separated from the translation service 9 with the automatic translation service 11 being located on a completely different architecture outside the IT structure of the translation service 9.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In an embodiment of the present inventive subject matter, the agent software locally stores translations of text messages once they have been requested from the translation service. In this case, if the message text is not provided in the target language, the agent software first verifies if a translation of the message text into the target language is locally available on the client computer. If the translation of the message text in the target language is available, it is displayed by the agent software to the user without contacting the translation service. Otherwise, the agent software requests a translation of the message text into the target language as already described. If a message text has to be displayed a second time on the client, a time consuming request to the translation service can be avoided.

In this situation, the agent software stores the translation of the message text locally on the client computer. This allows amplifying the number of translations of message texts on the client computer, so that for these message texts the translation service does not have to be contacted. Also the amount of data for storing translations of the message texts is kept small, because only such translations are stored, which have already been used and are therefore supposed to be relevant. Accordingly, the translation software has to deal with a reduced number of requests for translations of message texts.

In an embodiment of the present inventive subject matter, providing the translation of the message text into the target language to the agent software comprises the translation service passing the message text to an automatic translation service and providing a translation of the message text into the target language received from the automatic translation service to the agent software. This enables using the translation service as a pure online solution for providing the translation, so that the management activity can be performed without a delay due to a missing translation of the message text.

To further reduce the response time of the translation service, providing the translation of the message text into the target language to the agent software comprises the translation service verifying if a translation of the message text in the target language is locally available at the translation service and in case at least one translation of the message text in the target language is locally available at the translation service, providing one locally available translation of the message text to the agent software. Accordingly, only translations of message texts which are not locally provided have to be requested from the automatic translation service, e.g. a set of a frequently used message text can be provided as translation into different languages. Accordingly, the automatic translation service has to be requested in fewer cases, thereby reducing the response time of the translation service. The translation service has access to a storage medium for storing these message texts. This storage can be provided initially with a set of translations of message texts, e.g. frequently used message texts. Translations of the message texts which are provided by the automatic translation service can be stored for the further use of the translation service. Message texts, that have proven important due to their prior use, can be provided more rapidly by just providing them from the locally available translations of message texts. The automatic translation service can be provided as part of the translation service, as a separate service located inside the company network, or externally as a third party automatic translation service, the latter e.g. known as “babel fish” or “translate.google.com”.

In an embodiment of the present inventive subject matter, providing the locally available translation of the message text comprises selecting a preferred translation of the message text into the target language from a set of available translations of the message text into the target language and providing it to the agent software. In case multiple translations of the message text are available, certain criteria can be applied to the available translations for allowing choosing the most suitable translation. The criteria can be automatically generated, like a most frequently selected translation or a last chosen translation, or can be based on a human interaction, e.g. a voting of the available translations. Also in case just one translation of the message text is available, also the criteria can be applied just that all criteria are matched automatically by the only available translation of the message text. Locally available translations comprise translations from the storage of the translation service and translations from automatic translation services.

In an embodiment of the present inventive subject matter the agent software requests feedback from the user to the translation of the message text and the agent software providing the feedback to the translation service. The user feedback can be introduced into the system to introduce a human knowledge into the translation service and to improve the quality of the translated message text. This allows combining the advantages of automated translation done by a machine in a short time with the quality improvement achieved by the feedback from the human user.

In a further preferred embodiment the agent software evaluates a permission of the user for giving feedback and requesting feedback only from a user having this permission. This results in a restriction on giving a feedback to the provided translation to qualified users, e.g. developers with a high technical expertise or language experts with experience in translation from the original language into the target language. Other users, who might reduce the quality of the feedback, because they are not qualified, are excluded and a high quality translation of the message text into the target language is achieved. One possible implementation of such a restriction could be done in an initial delivery state of the software or the new version of the software, where the software is first verified by administrative users or developers before it is provided to all clients. After a release to all users, the request for a feedback can be disabled so that a stable software product is provided.

In an embodiment of the present inventive subject matter requesting feedback from a user to the translation of the message text comprises entering an alternate translation of the message text. Accordingly, the translation of the message text can be directly edited and provided to the translation service so that other users have access to the corrected translation. The corrected translation can be stored locally on the client and/or at the translation service in case a further access to this translation of the message text is required.

In a further preferred embodiment of the present inventive subject matter requesting feedback from a user to the translated message text comprises receiving multiple alternate translations of the message text from the translation service and selecting a preferred translation of the message text into the target language amongst the available translations of the message text into the target language. In case multiple translations are available, a preferred translation can easily be selected without the necessity for the user to provide a correct translation on its own. The translation service can receive information about the selected translation as a direct feedback on the available translations. Nevertheless, if the user is not satisfied with any of the available translations, in an even preferred embodiment of the inventive subject matter he can choose one of the available translations as a basis for providing a further translation which will then be added to the available translations at the translation service.

In an embodiment of the present inventive subject matter the agent software updates the translation of the message text displayed to the user. This allows the user to verify the editing, voting or translation tasks regarding the quality of the translation of the message text. In case the user is still not satisfied with the translation of the message text displayed, a further processing as already described before is possible.

In an embodiment of the present inventive subject matter the agent software uses a translation API installed on the client computer for providing the message text in the target language and communicating with the translation service. Accordingly, the agent software is independent from all kinds of translation tasks, so that any kind of modifications in the communication with the translation service or the policy of locally storing translations can be updated easily without affecting the agent software itself.

As will be appreciated by one skilled in the art, aspects of the present inventive subject matter may be embodied as a system, method or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for message text translation feedback as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for displaying a text message in a target language comprising:
performing a management activity that includes displaying a message text;
determining that a translation of the message text in the target language is locally unavailable;
requesting a translation of the message text into the target language from a translation service;
receiving, from the translation service, a plurality of different translations of the message text in the target language,
displaying the plurality of different translations of the message text in the target language;
requesting feedback about the plurality of different translations of the message text;
providing the feedback to the translation service; and
recording an indication of a vote for a preferred translation of the message text in the target language based on the feedback.

2. The method of claim 1 further comprising evaluating the feedback to determine the indication of the vote, wherein the feedback comprises marks for different technical translation aspects that at least include word translation and grammar translation.

3. The method of claim 2 further comprising storing the preferred translation of the message text locally on the client computer.

4. The method of claim 1 further comprising:
passing, by the translation service, the message text to an automatic translation service; and,
receiving, by the translation service from the automatic translation service, at least one of the plurality of different translations of the message text.

5. The method of claim 1 further comprising evaluating a permission of a user for giving feedback and determining that the user has permission to give feedback about the plurality of translations before said requesting the feedback about the plurality of translations.

6. The method of claim 5 further comprising receiving the preferred translation from the user via a user interface.

7. The method of claim 1, wherein the preferred translation is one of the plurality of translations.

8. The method of claim 1 further comprising:
determining, by the translation service, a one of the plurality of different translations of the message text with the most votes; and
storing the one of the plurality of different translations with the most votes at a client computer.

9. A computer program product for providing translations of message text in a target language, the computer program product comprising:
a computer readable storage medium having computer usable program code embodied therewith, the computer usable program code comprising a computer usable program code configured to:
perform a management activity that includes displaying a message text;
determine whether a translation of the message text in the target language is locally available;
if a translation of the message text in the target language is locally unavailable,
request a translation of the message text into the target language from a translation service;
receive a plurality of different translations of the message text in the target language,
display the plurality of different translations of the message text in the target language;
request feedback about the plurality of different translations of the message text;
provide the feedback to the translation service;
record an indication of a vote for a preferred translation of the message text in the target language based on the feedback;
if a translation of the message text in the target language is locally available, then display the locally available translation of the message text in the target language.

10. The computer program product of claim 9 further comprising the computer usable program code configured to evaluate the feedback to determine the indication of the vote, wherein the feedback comprises marks for different technical translation aspects that at least include word translation and grammar translation.

11. The computer program product of claim 9, wherein the computer usable program code is further configured to:
pass the message text to an automatic translation service; and,
receive, from the automatic translation service, at least one of the plurality of different translations of the message text.

12. The computer program product of claim 9, wherein the computer usable program code is further configured to evaluate a permission of a user for giving feedback and to request the feedback about the plurality of translations if the user has permission.

13. The computer program product of claim 12 further comprising computer usable program code configured to receive the preferred translation from the user via a user interface.

14. The computer program product of claim 9, wherein the preferred translation is one of the plurality of translations.

15. The computer program product of claim 9, wherein the computer usable program code is further configured to:
determine a one of the plurality of different translations of the message text with the most votes; and
store the one of the plurality of different translations with the most votes at a client computer.

16. An apparatus comprising:
a processor;
a machine-readable storage medium coupled with the processor, the machine readable storage medium having computer usable program code stored therein, the computer usable program code configured to, perform a management activity that includes displaying a message text;
determine whether a translation of the message text in the target language is locally available;
if a translation of the message text in the target language is locally unavailable,
request a translation of the message text into the target language from a translation service;
receive a plurality of different translations of the message text in the target language,
display the plurality of different translations of the message text in the target language;
request feedback about the plurality of different translations of the message text;
provide the feedback to the translation service;
record an indication of a vote for a preferred translation of the message text in the target language based on the feedback;
if a translation of the message text in the target language is locally available, then display the locally available translation of the message text in the target language.

17. The apparatus of claim 16 further comprising the computer usable program code configured to evaluate the feedback to determine the indication of the vote, wherein the feedback comprises marks for different technical translation aspects that at least include word translation and grammar translation.

18. The apparatus product of claim 16, wherein the computer usable program code is further configured to:
pass the message text to an automatic translation service; and,
receive, from the automatic translation service, at least one of the plurality of different translations of the message text.

19. The apparatus product of claim 16, wherein the computer usable program code is further configured to evaluate a permission of a user for giving feedback and to request the feedback about the plurality of translations if the user has permission.

20. The apparatus product of claim 19 further comprising computer usable program code configured to receive the preferred translation from the user via a user interface.
